(19) United States
(12) Patent Application Publication
(10) Pub. No.: US 2009/0198544 A1
(43) Pub. Date: Aug. 6, 2009

(54) SYSTEMS AND METHODS FOR FACILITATING DATA TRANSACTIONS IN TIME RECORDING SYSTEMS

(75) Inventor: Michael Lewis Williams, Roswell, GA (US)

Correspondence Address: SUTHERLAND ASBILL & BRENNAN LLP, 999 PEACHTREE STREET, N.E., ATLANTA, GA, 30309, US

(73) Assignee: ADVANCED PRODUCTIVITY SOFTWARE, INC., Atlanta, GA (US)

(21) Appl. No.: 12/365,786

(22) Filed: Feb. 4, 2009

Related U.S. Application Data
(60) Provisional application No. 61/025,966, filed on Feb. 4, 2008.

(51) Int. Cl. G06Q 10/00; G06K 7/00; G06F 7/06; G06F 17/30; G06F 15/16

(52) U.S. Cl. 705/7; 235/377; 707/3; 707/10; 709/201; 707/E17.014; 707/E17.044; 707/E17.032

(57) ABSTRACT

Systems and methods for facilitating data transactions in time recording systems may include receiving, at a client application from a timekeeper, a timekeeper identification. The received timekeeper identification and a request for time entry data associated with the timekeeper may be communicated to a middle-tier application that accesses at least one database to retrieve the requested time entry data and communicated the retrieved time entry data to the client application. The client application may receive the time entry data and store the received data in at least one local memory accessible by the client application. Upon the generation of a new time entry or the modification of an existing time entry at the client application, the time entry data stored in the at least one local memory may be updated. The updated time entry data may be communicated to the middle-tier application to facilitate updating the at least one database.

### CROSS REFERENCE TO RELATED APPLICATION

The present application claims the benefit of U.S. Provisional Application No. 61/025,966, filed Feb. 4, 2008, and entitled “Systems and Methods for Facilitating Data Transactions in Time Recording Systems.” The disclosure of the provisional application is incorporated by reference herein in its entirety.

### FIELD OF THE INVENTION

Embodiments of the invention relate generally to systems and methods for facilitating continuous access to multi-level data systems without regard to connection status and more particularly to systems and methods for facilitating stateless data transactions in time recording systems.

### BACKGROUND OF THE INVENTION

A variety of organizations require that professionals record their time, either to monitor work progress or to bill professional services out to third parties. Traditionally, professionals would fill out paper timesheets, which would be compiled and processed by additional staff, resulting in a time and staff intensive process that lowered overall productivity and resulted in suboptimal time recording percentages.

The adoption of computers greatly increased the efficiency and potential for time recording. Systems were eventually designed around a client and server database model, in which professionals could record their time on client applications that would then store records on a server. These conventional systems allowed additional functionality with regards to the stored records, such as the ability to search for cost codes, customer names, or other data sets that required validation.

These conventional time recordation systems, however, include several major drawbacks. For example, large organizations could have hundreds or thousands of timekeepers, with each timekeeper's day being divided into several time entries. Each time entry in these systems is typically validated against tables containing thousands of cost codes before it can be stored or logged. Therefore, these conventional time entry systems are limited by the time needed to perform numerous complicated database queries. These conventional systems are also limited by the requirement for clients to be in continuous access to a server for both record creation and field value validation.

Additionally, today's mobile workforce has presented a number of problems that conventional time entry systems have been unable to solve. When professionals work off-site, they are often reduced to recording time outside of the system for later entry into a client application once they have access to a server. This wasteful double entry is preferable to the alternative: that of time not being recorded as it occurs, as this scenario often leads to a lower likelihood that the time is adequately entered into the client application. However, similar to paper timesheets, the recording of time outside of the time recordation system may lead to suboptimal time recordation percentages.

Accordingly, there exists a need for improved time recordation systems and methods that facilitate stateless data transactions and the accurate entry of time for professionals working on site and off site.

### BRIEF DESCRIPTION OF THE INVENTION

Some or all of the above needs and/or problems may be addressed by certain embodiments of the invention. Embodiments of the invention may include systems and methods for facilitating data transactions in a time recordation systems. In one embodiments, a method for facilitating data transactions in time recording systems may be provided. A timekeeper identification may be received at a client application from a timekeeper. The received timekeeper identification and a request for time entry data associated with the timekeeper may be communicated to a middle-tier application that accesses at least one database to retrieve the requested time entry data and communicated the retrieved time entry data to the client application. The client application may receive the time entry data and store the received data in at least one local memory accessible by the client application. Upon the generation of a new time entry or the modification of an existing time entry at the client application, the time entry data stored in the at least one local memory may be updated. The updated time entry data may be communicated to the middle-tier application to facilitate updating the at least one database.

In accordance with another embodiment, a system for tracking time entries in a time recordation system is provided. The system may include a network interface, at least one local memory, and at least one processor. The network interface may be operable to transmit, to a host server via a network, a timekeeper identification and a request for time entry data for a timekeeper and to receive, from the host server via the network, time entry data for the timekeeper. The network interface may further be operable to transmit, to the host server via the network, updated time entry data. The at least one local memory may be operable to store time entry data. The at least one processor may be operable to receive, from a timekeeper, the timekeeper identification associated with the timekeeper and to direct the network interface to transmit the timekeeper identification and the request for time entry data to the host server. The at least one processor may further be operable to direct the storage of the received time entry data in the at least one local memory. The at least one processor may further be operable to generate a new time entry or modify an existing time entry, to direct the updating of the time entry data stored in the at least one local memory based at least in part on the generated or modified time entry, and to direct the network interface to transmit the updated time entry data to the host server.

Additional systems, methods, apparatus, features, and aspects are realized through the techniques of various embodiments of the invention. Other embodiments and aspects of the invention are described in detail herein and are considered a part of the claimed invention. Other advantages and features can be understood with reference to the description and drawings.

### BRIEF DESCRIPTION OF THE FIGURES

Having thus described the invention in general terms, reference will now be made to the accompanying drawings, which are not necessarily drawn to scale, and wherein:

FIG. 1 is a block diagram of one example time recording system in accordance with an illustrative embodiment of the invention.

FIG. 2 is a flow diagram illustrating one example operation of the various components of an embodiment of the invention.

FIG. 3 is a flow chart illustrating one example method for the general operation of a client application in accordance with one embodiment of the invention.

FIG. 4 is a flow chart illustrating one example method for the general operation of a middle-tier and/or host module in accordance with one embodiment of the invention.

FIGS. 5-8 illustrate example graphical user interfaces that may be utilized in various embodiments of the invention.

### DETAILED DESCRIPTION OF THE INVENTION

Example embodiments of the invention now will be described more fully hereinafter with reference to the accompanying drawings, in which some, but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As utilized herein, the term “client” may refer to one or more software applications executed by or running on one of the workstations 105, 110, 135, either within the network, across the internet or disconnected from both the internet and the network. The “client” may include one or more software applications that facilitate the entry or recordation of time by a professional or other individual. Additionally, as utilized herein, the term “application” refers to the totality or entirety of the various software and/or software components executed by the workstation and the server or middle-tier that facilitate time recordation and/or validation.

As used herein, the term “client application” may refer to an application that is executed on a client computer, for example, a personal computer, desktop computer, or laptop computer. In certain embodiments of the invention, the client application may be a time recordation and/or time entry application. The “client application” may include one or more software applications that facilitate the entry or recordation of time by a professional or other individual. Additionally, the term “client application” may refer to the totality or entirety of the various software and/or software components executed by the workstation and the server or middle-tier that facilitate time recordation and/or validation. Accordingly, the terms “client application,” “client,” “time recordation application,” and “time entry application” may be utilized interchangeably. The execution of the client application on a client computer may form a special purpose computer that facilitates the recordation, editing, and or tracking of time entries by a user of the client computer. In various embodiments of the invention, the client computer may periodically be in communication with a server or host computer. In this regard, the client application may periodically be in communication with a middle-tier application that is executed by the server.

As used herein, the term “middle-tier application” may refer to an application that is executed on a host computer, for example, a server. In certain embodiments of the invention, the middle-tier application may be a time recordation and/or time entry management application. As desired, the middle-tier application may receive time entry information from any number of client applications, and the middle-tier application may manage and/or consolidate the received information in one or more central data sources. In this regard, the middle-tier application may facilitate the management and/or update of a central database of time entry information. The terms “middle-tier application,” “host application,” “host module,” “database management application,” and “time entry management application” may be utilized interchangeably. The execution of the middle-tier application on a server or host computer may form a special purpose computer that facilitates the management and/or updating of time entries made by any number of client applications.

As used herein, the term “middle-tier” may refer to a host computer or server that may be utilized to execute a middle-tier application. The terms “middle-tier,” “host,” “host computer,” “host server,” and “server” may be utilized interchangeably.

Disclosed are systems and methods for time recording that allows for stateless database transactions. One or more copies of database information may be stored locally, but without the need for a client side database or database engine. Data may be cached in a suitable memory associated with a client computer for instantaneous access and manipulation, minimizing the wait time server queries necessitate. The time entry system may function in a similar manner when it is operating online and offline. With no states for the client application to switch between, usability may be improved, simplifying the experience from an end-user's perspective. Processing, editing, and/or manipulation of time entry information may be facilitated locally on a client computer. Such local processing may increase the performance of the overall time entry system by reducing or eliminating the time in which a client application waits on a server or middle-tier application.

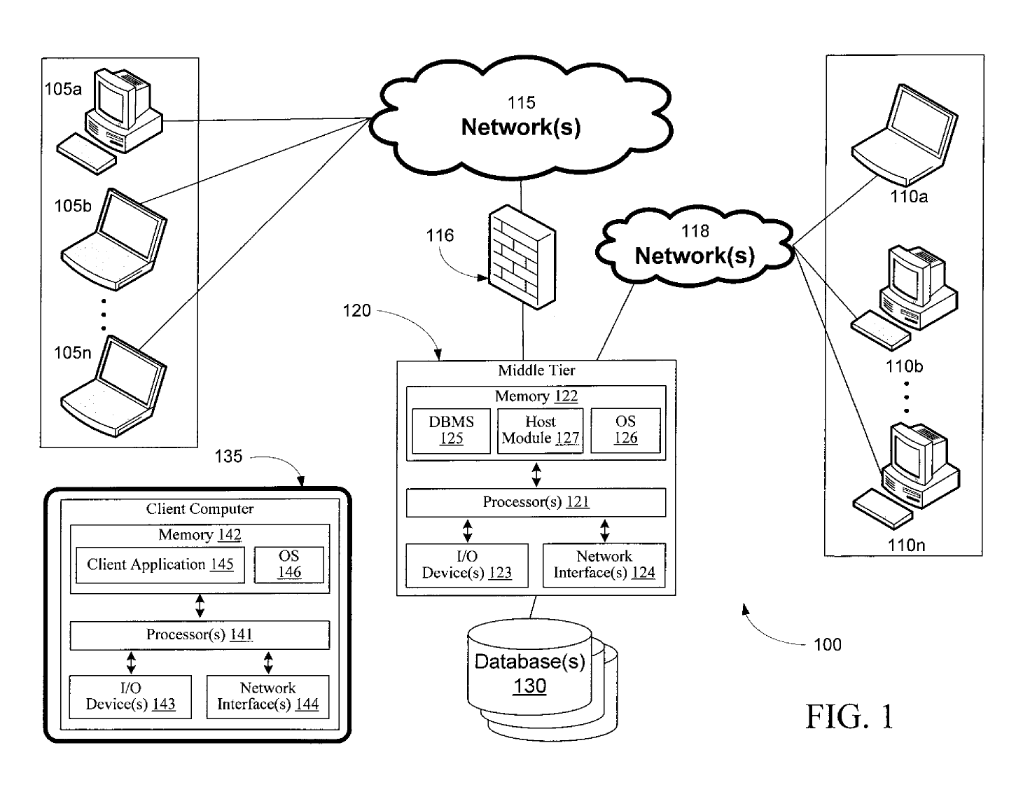

FIG. 1 is a block diagram of one example time recording system 100 in accordance with an illustrative embodiment of the invention. The system 100 of FIG. 1 may facilitate one or more stateless database transactions relating to time entry information. The time recording system 100 may include one or more workstations or client computers, such as workstations 105a-n and 135 and networked workstations 110a-n, a middle-tier 120, host computer, or server, and at least one database 130.

Each workstation 105a-n, 110a-n, 135 may be any suitable computing device as desired in various embodiments of the invention, for example, a personal computer, a minicomputer, a personal digital assistant (PDA), a mobile device, etc., that is operable to execute at least one client application that facilitates time entry and/or time recordation by a professional or other user. Additionally, each workstation 105a-n, 110a-n, 135 may operate in either an online mode or an offline mode. In an online mode, a workstation 105a-n, 110a-n, 135 may be in communication with a middle-tier 120 or server. The communication with the middle-tier 120 may be facilitated via any number of suitable networks as explained in greater detail below. In an offline mode, a workstation 105a-n, 110a-n, 135 may be operated as a standalone workstation that is not in communication with a middle-tier 120 or server. As shown in FIG. 1, certain workstations 105a-n may be in communication with the middle-tier 120 via a wide area network, for example, the Internet. Other workstations 110a-n may be in communication with the middle-tier 120 via a local area network, for example, a local area network in an office building at which one or more professionals work. Additionally, as shown in FIG. 1, at least one workstation 135 may operate in an offline mode in which it is not in communication with the middle-tier 120. For purposes of this disclosure, the components of the offline workstation 135 are discussed in greater detail below. The other workstations 105a-n, 110a-n may include similar components as those described for the offline workstation 135. Additionally, for purposes of this disclosure, the term workstation 135 may be utilized to refer to any workstation unless otherwise noted.

The workstation 135 may be a processor driven device that facilitates the time entry and/or time recordation by a professional or other user. For example, the workstation 135 may include any number of special purpose computers, application specific circuits, microcontrollers, and the like. In certain embodiments, at least a portion of the operations of the workstation 135 may be controlled by computer-executed or computer-implemented instructions that are executed by one or more processors associated with the workstation 135. The instructions may be embodied in one or more software components as desired in various embodiments of the invention. The execution of the instructions may form a special purpose computer that is operable to facilitate time entry at the workstation and that is further operable to communicate with the middle-tier 120 to facilitate the maintenance of a repository of time entry information. Additionally, in certain embodiments of the invention, the operations and/or control of the workstation 135 may be distributed amongst several processing components.

The workstation 135 may include one or more processors 141, one or more memory devices 142, one or more input/output (“I/O”) interface(s) 143, and one or more network interface(s) 144. The one or more memory devices 142 may be any suitable memory devices, for example, caches, read only memory devices, random access memory devices, magnetic storage devices, etc. In certain embodiments of the invention, the one or more memory devices 142 may be local memory devices associated with the workstation 135. The one or more memory devices 142 may store data, executable instructions, and/or various program modules utilized by the workstation 135, for example, validation data and/or time entry data that is received from the middle-tier 120, validation data and/or time entry data that is received from a user of the workstation 135, a client application 145, and/or an operating system 146.

In certain embodiments of the invention, the workstation 135 may include one or more software modules, such as a client application 145 and/or an operating system 146. The operating system 146 may control the general operation of the workstation 135, for example, the execution of other software modules and/or software applications, including but not limited to the client application 145. The client application 145 may include computer-executable instructions that facilitate the receipt of time entry information and/or time recordation information from a user of the workstation 135 and/or from the middle-tier 120. The client application 145 may further include computer-executable instructions that facilitate the communication of time entry information to the middle-tier 120. For example, the client application 145 may facilitate and/or control the receipt of validation information from the middle-tier 120, the receipt of login information from a user, the storage of validation information, the receipt of time entry information from the middle-tier 120, the receipt of time-entry information from a user, the storage of time-entry information, the establishment of a communication session with the middle-tier 120, and/or the communication of time-entry information to the middle-tier 120. Although the client application 145 is illustrated as a single software component, the client application 145 may include any number of software components, modules, and/or applications as desired in various embodiments of the invention.

The one or more I/O interfaces 143 may facilitate communication between the workstation 135 and one or more input/output devices, for example, one or more user interface devices, such as, a display, keypad, keyboard, mouse, control panel, touch screen display, microphone, etc. that facilitate user interaction with the workstation 135. In this regard, login information and/or time entry information may be received from a professional or other user and processed by the workstation 135. Additionally, various information, such as user prompts and/or time entry information, may be displayed to a professional or other user by the workstation 135.

The one or more network interfaces 144 or communications interfaces may facilitate connection of the workstation 135 to one or more suitable networks 115, 118, for example, a local area network, a wide area network, the Internet, a cellular network, any wired network, any wireless network, etc. In this regard, the workstation 135 may receive validation information and/or time entry information from the middle-tier 120. The workstation 135 may also communicate various information, such as time entry information to the middle-tier 120.

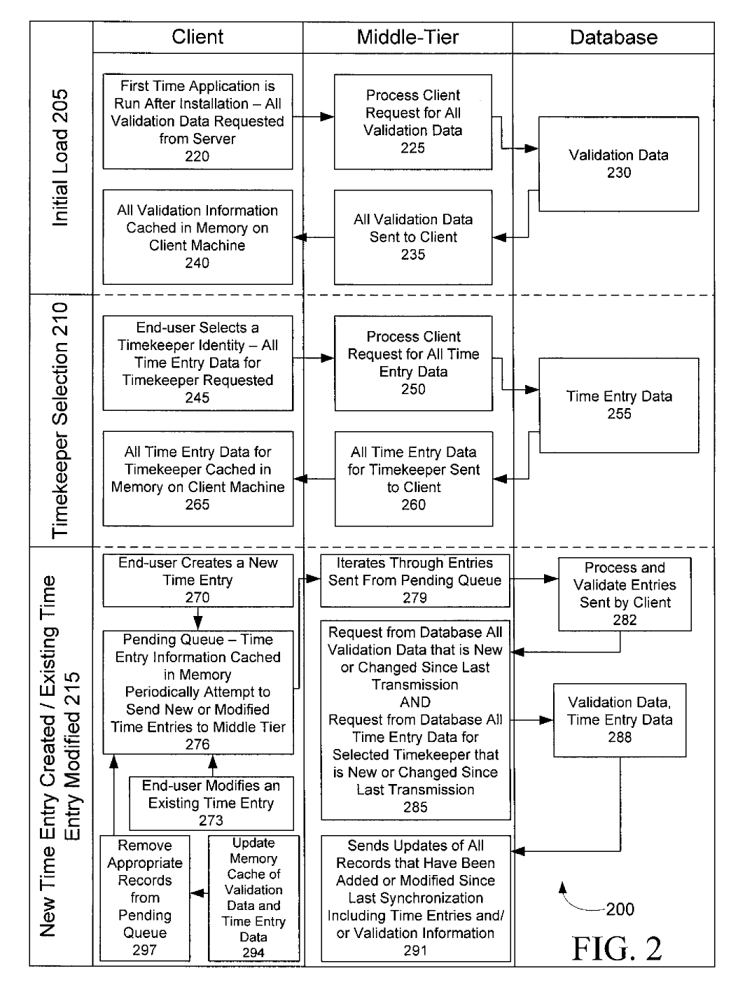

According to an aspect of the invention, the workstation 135 may receive validation data and/or other validation information from a middle-tier 120 the first time that the client application 145 is executed on the workstation 135 and in communication with the middle-tier 120. For example, the workstation 135 may request and receive validation data from the middle-tier 120 during an installation process for the client application 145 and/or when client application 145 is executed for the first time following installation. A wide variety of validation data may be utilized as desired in various embodiments of the invention. Examples of suitable validation data are discussed in greater detail below with reference to FIG. 2. The received validation data may be stored in a suitable memory 142 associated with the workstation 135 and utilized as desired to validate time entries that are entered by a professional or other user that is utilizing the client application 145.

According to another aspect of the invention, the workstation 135 may receive various time entry data, time recordation information, and the like from a middle-tier 120. Time entry data may be received at a wide variety of times as desired in various embodiments of the invention. For example, when a professional or other user logs into the client application 145, time entry data for the professional or other user may be requested from and received from the middle-tier 120. The request for time entry information associated with the professional may include a timekeeper identifier for the professional. Received time entry information may be stored in one or more suitable memory devices 142 associated with the workstation 135. The workstation 135 and client application 145 may facilitate the editing, supplementing, and/or manipulating of the stored time entry data by the professional or other user. Following any additions and/or changes that are made to the time entry data, the workstation 135 and client application 145 may facilitate the communication of the additions and/or changes to the middle-tier 120.

Embodiments of the invention may include workstations 135 with more or less than the components illustrated for the workstation 135 illustrated in FIG. 1. The description of the workstation 135 of FIG. 1 is provided by way of example only and is not intended to be limiting.

The middle-tier 120 may include one or more computing devices and associated software, for example, a server and/or various software modules executed by the server. The middle-tier 120 may be any suitable computing device as desired in various embodiments of the invention, for example, a personal computer, server, mainframe computer, etc., that is operable to execute at least one software application that facilitates the communication of time entry and/or time recordation to and from any number of workstations 135 and/or the management of a central repository of time entry and/or time recordation information.

The middle-tier 120 may be a processor driven device that facilitates the communication of time entry and/or time recordation information to and from any number of workstations 135 and/or the management of a central repository of time entry and/or time recordation information. For example, the middle-tier 120 may include any number of special purpose computers, application specific circuits, microcontrollers, and the like. In certain embodiments, at least a portion of the operations of the middle-tier 120 may be controlled by computer-executed or computer-implemented instructions that are executed by one or more processors associated with the middle-tier 120. The instructions may be embodied in one or more software components as desired in various embodiments of the invention. The execution of the instructions may form a special purpose computer that is operable to facilitate the management of a central repository of time entry information that is further operable to facilitate communications with any number of workstations 135. Additionally, in certain embodiments of the invention, the operations and/or control of the middle-tier 120 may be distributed amongst several processing components.

The middle-tier 120 may include one or more processors 121, one or more memory devices 122, one or more input/output (“I/O”) interface(s) 123, and one or more network interface(s) 124. The one or more memory devices 122 may be any suitable memory devices, for example, caches, read only memory devices, random access memory devices, magnetic storage devices, etc. The one or more memory devices 122 may store data, executable instructions, and/or various program modules utilized by the middle-tier 120, for example, time entry data that is received from a workstation 135, validation data and/or time entry data that is accessed from third party data sources.

In certain embodiments of the invention, the middle-tier 120 may include one or more software modules, such as a database management system (DBMS) 125, an operating system 126, and/or a host module. The operating system 126 may control the general operation of the middle-tier 120, for example, the execution of other software modules and/or software applications, including but not limited to the DBMS 125 and the host module 127. The DBMS 125 may facilitate interaction between the host module 127 and one or more databases 130, including but not limited to, the accessing, updating, and/or supplementing of time entry information and/or validation information that is stored in the one or more databases 130. The host module 127 may include computer-executable instructions that facilitate the receipt of time entry information and/or time recordation information from a workstation 135 and the updating of a central repository of time entry information. The host module 127 may also include computer-executable instructions that facilitate the receipt of requests for validation information, time entry information, and/or time recordation information from a workstation 135, and the communication of the requested information to the workstation 135. For example, the host module 127 may facilitate and/or control the communication of validation information to a workstation 135, the communication of time entry information to a workstation 135, the receipt of time entry information from a workstation 135, the comparison of received time entry information to stored time entry information, the updating of time entry information, and/or the storage of received and/or updated time entry information. Although the host module 127 is illustrated as a single software component, the host module 127 may include any number of software components, modules, and/or applications as desired in various embodiments of the invention.

The one or more I/O interfaces 123 may facilitate communication between the middle-tier 120 and one or more input/output devices, for example, one or more user interface devices, such as, a display, keypad, keyboard, mouse, control panel, touch screen display, microphone, etc. that facilitate user interaction with the middle-tier 120. In this regard, user preferences and/or other inputs may be received from a user of the middle-tier 120. Additionally, various information, such as user prompts and/or time entry information, may be displayed to a user by the middle-tier 120.

The one or more network interfaces 124 or communications interfaces may facilitate connection of the middle-tier 120 to one or more suitable networks 115, 118, for example, a local area network, a wide area network, the Internet, a cellular network, any wired network, any wireless network, etc. In this regard, the middle-tier 120 may communicate with one or more workstation 135.

According to an aspect of the invention, the middle-tier 120 may receive requests for validation data, validation information, and/or time entry data from a workstation 135 in communication with the middle-tier 120. For example, the middle-tier 120 may receive a request for validation data from a workstation 135 on which a client application 145 is executed for the first time. As another example, the middle-tier 120 may receive a request for time entry data from a workstation 135 following the entry of a timekeeper identity at the workstation 135. The middle-tier 120 may process the received requests, access requested information from the one or more databases 130, and communicate the requested information to the workstation 135. Additionally, the middle-tier 120 may receive time entry information from a workstation 135, and the middle-tier 120 may update time entry records stored in the one or more databases 130 if the received time entry information differs from that stored in the one or more databases 130.

Embodiments of the invention may include middle-tiers 120 with more or less than the components illustrated for the middle-tier 120 illustrated in FIG. 1. The description of the middle-tier 120 of FIG. 1 is provided by way of example only and is not intended to be limiting.

With reference to FIG. 1, one or more networked workstations 110a-n may be connected to the middle-tier service 120 by one or more suitable networks 118 and one or more suitable network connections, for example, a HTTP or HTTPS network connection. Workstations outside of the network, such as workstations 105a-n, may be in communication with the middle-tier service 120 via an appropriate Internet connection 115, for example, an HTTPS internet connection. It will be appreciated that any Internet connection to the middle-tier service 120 may be ported through one or more firewalls, such as firewall 116.

With continued reference to FIG. 1, the middle-tier 120 may be in communication with the at least one database 130. The middle-tier 120 may operate to read from and/or write to the database. In this regard, the middle-tier 120 may maintain a central repository of time entry information. As desired, the middle-tier 120 may also maintain a central repository of validation information.

The at least one database 130 may include any number of suitable memory devices that facilitate the storage of data associated with time recorded by any number of professionals. The at least one database 130 may also include any number of suitable memory devices that facilitate the storage of data associated with validation information for one or more professionals.

FIG. 2 is a flow diagram illustrating one example operation 200 of the various components of an embodiment of the invention. FIG. 2 generally illustrates the various processes of one or more time entry applications that are utilized in a time management system and the functionality of these processes at various layers or phases of time recordation by the various components of a time entry system, for example, the system 100 illustrated in FIG. 1.

For purposes of describing the operations illustrated in FIG. 2, the various layers of a time entry application may include an initial load, a timekeeper selection and the creation and/or editing of a time entry record. The term “initial load” generally refers to the first time a client application is executed at a workstation, where no persistent validation information preexists on the workstation. The term “timekeeper selection” generally refers to the end user (e.g., professional utilizing a workstation) designating an identity that is being used to access the system (e.g., a user name, employee number, etc.), so that records viewed and created are associated with that identity. The creation of a time entry record generally refers to creating a new record of time and associated information that does not yet exist. The editing of a time entry record generally refers to modifying an existing record of time and associated information.

Additionally, with reference to FIG. 2, the operations of the various components of a time entry system are described. A time entry system, for example, the system 100 illustrated in FIG. 1, may include at the very least a client application, a middle-tier, and a database. A “client application” may be a software application or client application executed by a personal computer or other device utilized by a professional during the normal course of business. A “middle-tier” may include one or more suitable devices, such as one or more servers or host computers, that are in communication with one or more clients. The “middle-tier” may facilitate communication of information between the one or more clients and a database. The “database” may include one or more suitable memory devices that form a centralized data storage for validation information and/or time entry information associated with potential time entries that may be received from the clients. The middle-tier may or may not reside on the same machine as the database.

With continued reference to FIG. 2, blocks 220-240 represent operations that may be performed during the initial load of time recordation information, which is generally represented by row 205 in FIG. 2. Similarly, blocks 245-265 represent operations that may be performed during timekeeper selection, which is generally represented by row 210 in FIG. 2, and blocks 270-297 represent operations that may be performed during the creation of new time entries or the modification of existing time entries, which is generally represented by row 215 in FIG. 2.

Blocks 220, 240, 245, 265, 270, 276, 294, and 297 represent operations that may be conducted by the client application. Similarly, blocks 225, 235, 250, 260, 279, 285, and 291 represent operations that may be conducted by the middle-tier and blocks 230, 255, 282, and 288 represent operations that may be conducted by or carried out utilizing the database.

At block 220, a client application may be executed for the first time by a workstation. The client application requests all validation data from the server. The validation data may include or consists of cost codes, names, and/or similar information that is utilized to ensure that time entries conform to designated business rules. Once the application is executed for the first time by a client application at block 220, operations may continue at block 225.

At block 225, the middle-tier may receive the request for validation data from a workstation or client machine, and the middle-tier may process the request in order to retrieve the requested validation data from the database at block 230.

Once the validation data is retrieved from the database at block 230, the validation data may be sent by the middle-tier service to the client application at block 235. The client application may store the received validation data into one or more suitable memory devices, for example, a cache associated with the workstation executing the client application, at block 240.

At block 245, the end-user selects a timekeeper identity. The timekeeper identity may consists of a name, code, or similar information that represents an individual or group under whom time is tracked within an organization. In certain embodiments of the invention, selecting the timekeeper identity may cause or lead the client application to request all the time entry data for that timekeeper identity, where a time entry may be a record of time and the associated activities, phases, tasks, descriptions, and related information.

At block 250, the middle-tier may process a received request from the client application for time entry data for a timekeeper identity and may request all of the time entry data for the selected timekeeper from the database in block 255, which the middle-tier may retrieve from the database at block 260 and delivers to the client application. At block 265, the client application may cache the time entry data in local memory. In this regard, time entry information for a timekeeper may be locally stored at a workstation utilized by the timekeeper. The timekeeper may supplement or edit the time entry information at the workstation without having a connection to the middle-tier or server. In this regard, time entry information may be accurately maintained by the timekeeper even if the workstation is utilized in an offline mode.

At block 270, an end-user may create a new time entry, which may be entered or recorded into a pending queue on the client machine or workstation, where the pending queue consists of such time entries cached in local memory. Similarly, at block 273, an end-user may modify an existing time entry that is stored in local memory associated with the client machine or workstation, and the modified existing time entry may be stored or recorded in the pending queue on the client machine.

At block 276, the pending queue may contain a list of time entries that were newly created by the client at block 270 and/or existing time entries which were modified by the client application at block 273. The workstation or client machine may periodically attempt to add this information to and/or update this information on the database by establishing a connection with the middle-tier, if a connection is available, and communicating the information to the middle-tier for adding/updating of the database. As desired in various embodiments of the invention, the workstation may periodically attempt to establish a communication session or other connection with the middle-tier by utilize operations that are performed in the background or unbeknownst to the user of the workstation. Any period of time may be utilized as desired in various embodiments of the invention, for example, every minute, every five minutes, every 15 minutes, every hour, etc. Alternatively, the workstation may attempt to establish a communication session or other connection with the middle-tier upon the occurrence of a predefined event, for example, the entry of time entry information by a user, the editing of time entry information by a user, the stopping of a clock that is utilized in association with a time entry, etc. In other embodiments of the invention, the workstation may attempt to establish a communication session or other connection with the middle-tier based at least in part on instructions received from a user of the workstation to establish a communication session.

At block 279, the middle-tier may iterate through the received time entries sent from the pending queue of the client machine, and the middle-tier may process the received time entries by updating the database at block 282. This processing may include one or more of validating that the time entries comply with one or more business rules, logging the activity being completed, logging the time of the operation, determining if entries are to be inserted or updated, triggering stored procedures, and/or many other related processes that may be desirable in certain embodiments of the invention.

At block 285, the middle-tier may request all validation data that is new or updated since the last transmission from the database to the client, and request all time entries for the selected timekeeper that are new or updated since the last transmission from the database to the client application. As a result of the processing in block 282, the new or modified time entries from block 270 or block 273 may be included in the information requested in block 285. The data may be retrieved from the database at block 288 and then sent by the middle-tier to the client application at block 291. This data may then be cached in local memory by the client application at block 294.

At block 297, any records that were included in the data set from block 291 that were also listed in the pending queue at block 276 may be identified. If not already removed, any records that have made the trip from the pending queue to the database and then back to the server may be removed. As a result, these records are no longer present in the pending queue, and are instead enumerated among the rest of the time entries that are not new or modified by the client.

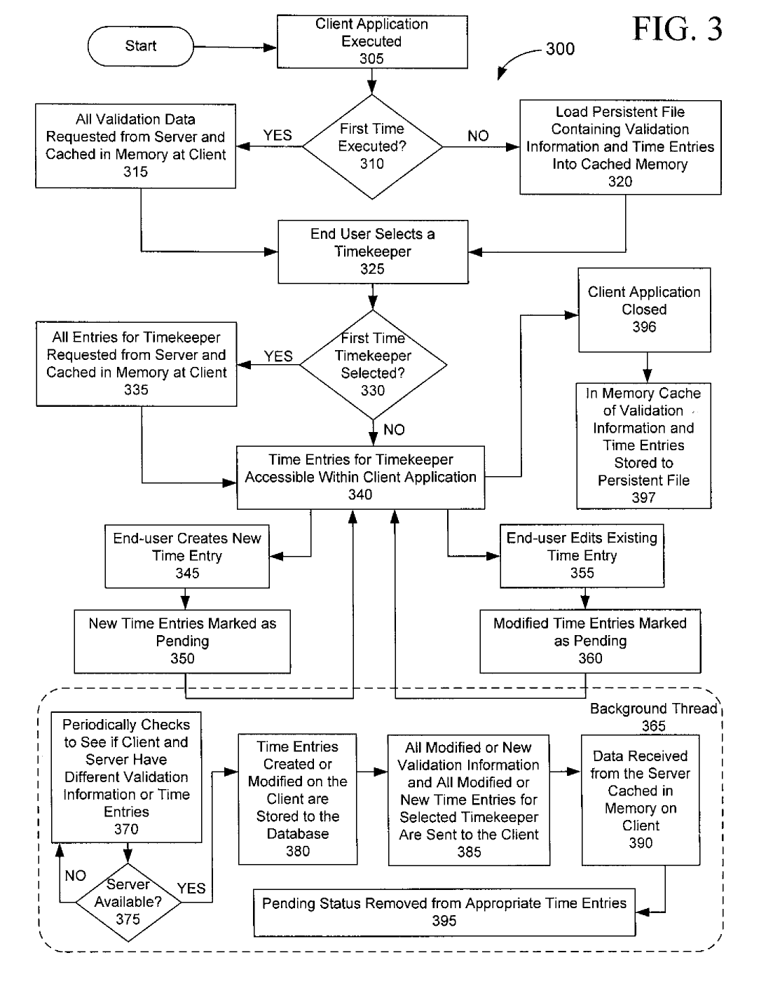

FIG. 3 is a flow chart illustrating one example method 300 for the general operation of one embodiment of the invention. Generally, FIG. 3 illustrates the operations that may be performed by an application executing on a client for time recordation, for example, the operations performed by the client application 145 illustrated in FIG. 1. Additionally, FIG. 3 illustrates operations that may occur in the background between the client application and a middle-tier in communication with a database in order to verify, validate, and/or update time entry or recordation information.

With general reference to FIG. 3, the illustrated operations may be performed by a client application such as for example, one or more suitable software applications executing on one of the workstations or personal computers depicted in the time recordation system 100 illustrated in FIG. 1. Additionally, the background operations may be facilitated by at least one database and a middle-tier in communication with a personal computer, for example, the middle-tier 120 and database 130 depicted in the time recordation system 100 of FIG. 1.

With continued reference to FIG. 3, blocks 305-360 and blocks 396-397 represent operations that may be performed by a main application executed on a client, while blocks 365-395 may represent the operations of a separately processed background thread.

The method 300 may start at block 305. At block 305, a client application may be executed by a workstation. A determination may be made at block 310 as to whether the client application is being executed for the first time on the workstation. If it is determined at block 310 that it is the first time the client application is executed, then a portion of or all validation data may be requested from the middle-tier or server at block 315 and received and cached in a local memory on the workstation. If, however, it is determined at block 310 that it is not the first time the application is executed, then a portion of or all validation data and time entry data that are stored in a persistent file on the local machine or workstation may be loaded into local cached memory at block 320. In this regard, the speed of the client application may be increased or enhanced by removing the dependence on server or middle-tier speed for individual transactions. It also allows for validation information to be available from outside the network environment after the initial load.

At block 325, the end-user (e.g., a professional utilizing the workstation) may select a timekeeper. A determination may be made at block 330 as to whether the timekeeper has been selected for the first time. If it is determined at block 330 that it is the first time a timekeeper is selected, then a portion of or all time entries for that timekeeper may be requested from the server and cached in local memory on the workstation at block 335. The time entries for that timekeeper may then be made accessible to the client application at block 340. If it is determined at block 330 that it is not the first time that the timekeeper has been selected selected, then the loading of the persistent file at block 320 may included the timekeeper's time entries, and they would be available to the client application at block 340 immediately upon choosing a timekeeper at block 325. In this regard, time entry creation and modification from outside the network environment on subsequent use of the application may be facilitated, as records cached in local memory will be stored to a persistent file for later access at block 320. Additionally, the modification of time entries may be facilitated without waiting on the server, which has previously been a limiting speed factor in time entry and recordation systems.

Once time entry record for a timekeeper are made available to a client application at block 340, a user may add to the time entry records and/or edit the time entry records. For example, the end-user may create a new time entry for the selected timekeeper at block 345, and the new time entry may then be marked as pending at block 350. The new time entry may then be made accessible to the end-user along with the other time entries at block 340.

At block 355, the end-user may modify an existing time entry from block 340, and, the modified existing time entry may be marked as pending at block 360 and made available to the end-user along with the other time entries at block 340.

In addition to the operations of the client application that interact with a user and/or facilitate the receipt of information from the user, a background thread may be executed by the workstation or client machine. The background thread may be a component of the client application or a separate software application that is associated with the client application. Additionally, the background thread may facilitate communication with the middle-tier and the updating of time entry records that are stored in a database that is managed by the middle-tier. In a background thread, illustrated generally as block 365, new and/or modified time entries may be uploaded to the middle-tier for entry into the database.

With reference to the background thread, at block 370, the client application in communication with the middle-tier periodically determines whether the validation information cached in local memory or time entry information for the selected timekeeper cached in local memory are identical to the information stored in the at least one database. Although operations of the background thread are described as validating time entry information, it will be appreciated that the end user (e.g., professional) may never be prevented from working with or creating time entries should the background thread fail to contact the server in various embodiments of the invention.

A determination may be made at block 375 whether the middle-tier or server is available and/or whether a communication session may be established between the client application and the middle-tier. If it is determined at block 375 that the server is available, then the background thread and the middle-tier may facilitate the storage of the created or modified records to the at least one database at block 380.

Additionally, as desired in various embodiments, all new or modified validation information or time entries for the selected timekeeper may be sent to the client application at block 385. In block 390, the received data may be cached in local memory on the workstation. Then, in block 395, the pending status may be removed from the new time entries from block 350 or modified time entries from block 360 that were included in the update carried out at block 380.

At block 396, the client application may be closed. When the client application is closed, the local in memory cache may be stored on the client machine or workstation in a persistent file at block 397. A persistent file may be a file that can be loaded during the next execution of the client application such as, for example, a file stored on one or more hard disk memories or other suitable memory storage devices. If the client application is initiated or started up again, then operations may continue at block 320.

The method 300 may end following block 397.

The operations described and shown in the method 300 of FIG. 3 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 3 may be performed.

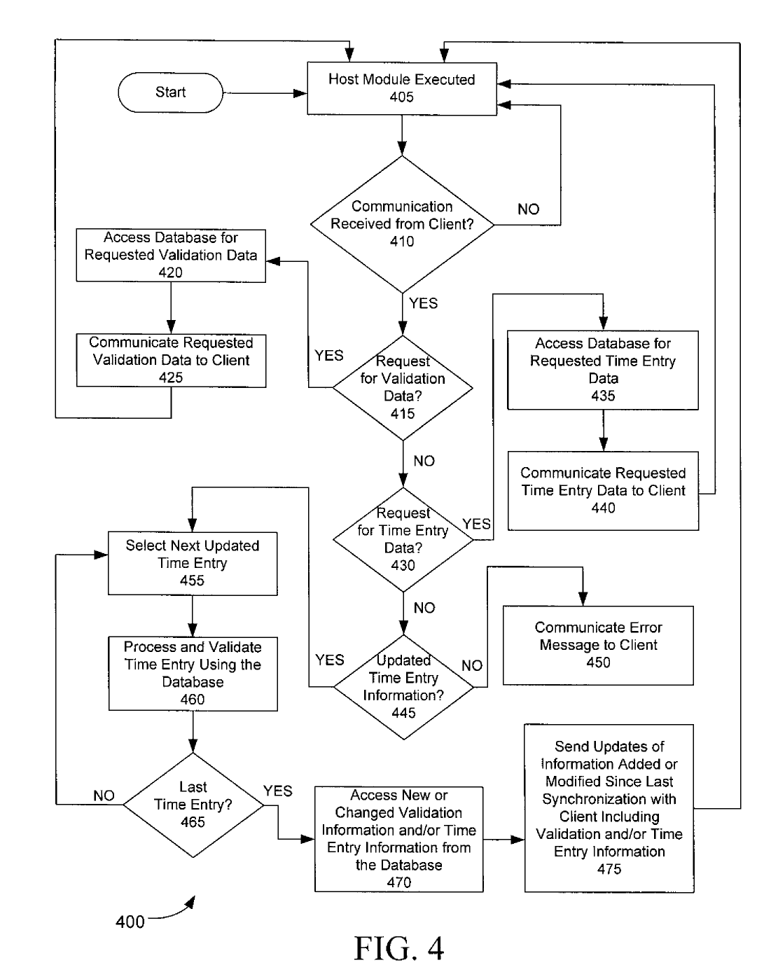

FIG. 4 is a flow chart illustrating one example method 400 for the general operation of a middle-tier and/or host module in accordance with one embodiment of the invention. The operations illustrated in FIG. 4 may be performed or executed by any suitable application that facilitates communication between a client application, such as client application 145 illustrated in FIG. 1, and a central repository of time recordation information, such as the database 130 illustrated in FIG. 1. For example, the operations illustrated in FIG. 4 may be performed or executed by a suitable middle-tier and/or a host application or host module associated with the middle-tier. Examples of a suitable middle-tier and host module are the middle-tier 120 and host module 127 illustrated in FIG. 1.

With reference to FIG. 4, the method may begin at block 405. At block 405, a host module application 127 may be executed at a middle-tier 120. The host module application 127 may be operable to receive requests for validation data and/or time entry data from any number of client applications 145 as desired in various embodiments of the invention. The host module application 127 may facilitate processing of received requests and, in doing so, may facilitate communication between the client applications 145 and the database 130. Additionally, the host module application 127 may be operable to receive new and/or updated time entry information from any number of client applications 145. The host module application 127 may validate the received time entry information and update the database 130 utilizing at least a portion of the received time entry information. In this regard, the host module application 127 may facilitate the maintenance of an accurate and up-to-date central repository of time entry and/or time recordation information.

Once the host module application 127 is executed at block 405, the host module application 127 may enter a loop until a communication is received from a client application 145. A determination may be made at block 410 as to whether one or more communications have been received from a client application 145. If it is determined at block 410 that no communications have been received, then operations may continue at block 405. If, however, it is determined at block 410 that a communication has been received from a client application 145, then operations may continue at block 415.

At block 415, a determination may be made as to whether the received communication includes a request from a client application 145 for validation data and/or other validation information. For example, a client application 145 that is executed for the first time may request validation data from the middle-tier 120. If it is determined at block 415 that the communication does not include a request for validation data, then operations may continue at block 430 below. If, however, it is determined at block 415 that the communication includes a request for validation data, then operations may continue at block 420. At block 420, one or more suitable databases, such as database 130, may be accessed to gather the requested validation data, and the requested validation data may be communicated to the client application 145 at block 425. Operations may then continue at block 405.

At block 430, a determination may be made as to whether the received communication includes a request from a client application 145 for time entry data and/or time recordation data. For example, a client application 145 may request time entry data for a particular timekeeper one the timekeeper has been identified by the client application 145. If it is determined at block 430 that the communication does not include a request for time entry data, then operations may continue at block 445 below. If, however, it is determined at block 430 that the communication includes a request for time entry data, then operations may continue at block 435. At block 435, one or more suitable databases, such as database 130, may be accessed to gather the requested time entry data, and the requested time entry data may be communicated to the client application 145 at block 440. Operations may then continue at block 405.

At block 445, a determination may be made as to whether the communication from the client application 145 includes updated time entry information. Updated time entry information may include time entry information associated with new time entries and/or modified time entries. This updated time entry information may be stored in pending queue by the client application 145 and communicated to the host module application 127. If it is determined at block 445 that no updated time entry information is included in the communication, then operations may continue at block 450 and one or more appropriate error messages may be communicated or transmitted to the client application 145. For example, an error message indicated that the received communication did not include any recognizable data that could be processed by the host module application 127 may be communicated to the client application 145. If, however, it is determined at block 445 that the communication includes updated time entry information, then operations may continue at block 455.

If updated time entry information is received, then the host module application 127 may iterate through and process the various entries included in the updated time entry information. At block 455, the next updated time entry in the received information may be selected. The time entry may be processed and validated at block 460 utilizing a central repository of time entry information, such as database 130. During the processing and validation of the time entry, the time entry may be evaluated utilizing any number of validation rules and/or validation requirements as desired in various embodiments of the invention. If the time entry is validated, then the central repository of information may be updated with the validated time entry.

At block 465, a determination may be made as to whether the time entry that has been processed and validated at block 460 is the last time entry included in the received updated time entry information. If it is determined at block 465 that the time entry is not the last time entry, then operations may continue at block 455 and the next updated time entry may be selected. If, however, it is determined at block 465 that the time entry is the last time entry, then operations may continue at block 470. At block 470, new or changed validation information and/or time entry information may be accessed from the database. Updates information since the last synchronization with the client application 145, including updated validation information and/or time entry information, may then be transmitted or otherwise communicated to the client application 145 at block 475. Following the transmission at block 475, operations may continue at block 405.

The method 400 may continue while the host module application 127 is executed. The method 400 may end once the host module application 127 has been closed.

The operations described and shown in the method 400 of FIG. 4 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 4 may be performed.

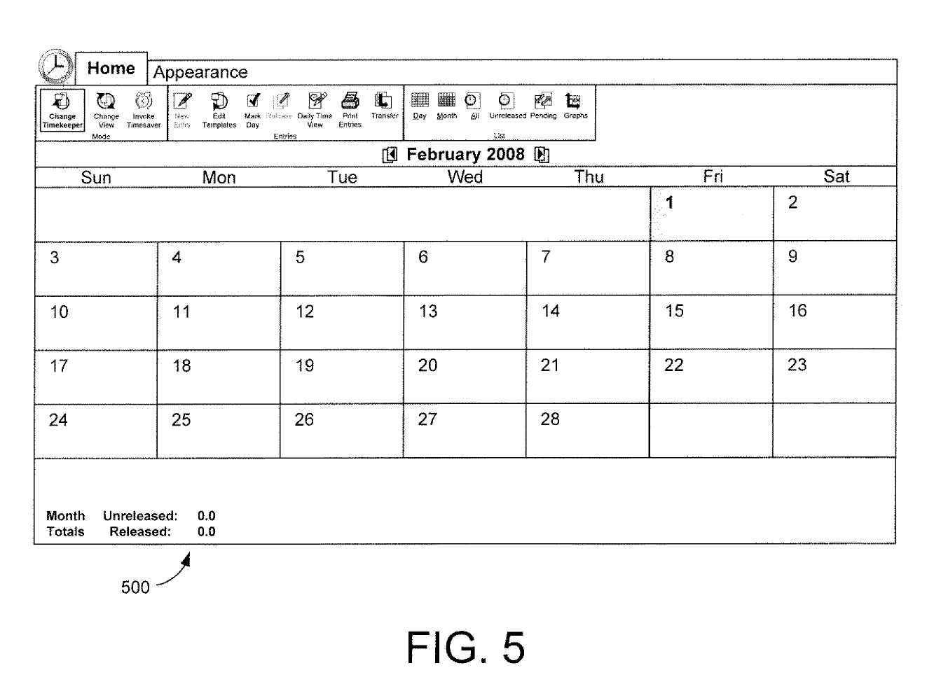

Various embodiments of the invention may include a client application, such as client application 145 illustrated in FIG. 1, that is executed on a workstation or client computer, such as workstation 135 illustrated in FIG. 1. The client application 145 may facilitate the gathering of time entry and/or time recordation information from a professional or other user as desired in various embodiments. The client application 145 may further facilitate the output of time entry information and other information relating to time entry to a professional or other user. In certain embodiments of the invention, the output of information and/or the gathering of information may be facilitated via one or more graphical user interfaces that are displayed to a user via one or more suitable output devices associated with a workstation 135, for example, a monitor or display associated with the workstation 135. A wide variety of graphical user interfaces may be utilized as desired in various embodiments of the invention. A few example graphical user interfaces are depicted in FIGS. 5-8 and briefly described below.

FIG. 5 illustrates one example graphical user interface (GUI) screen 500 that may be displayed to a professional or other user when a time recordation application is initialized. The screen 500 may display a calendar for the current month to the user. The user may select a day to enter time entry information for that day. The user may also change the display to view other months. Additionally functionality may be provided to the user as desired in various embodiments of the invention, for example, the ability to utilize timers to track time, the ability to request and/or generate various reports associated with time entry information, etc.

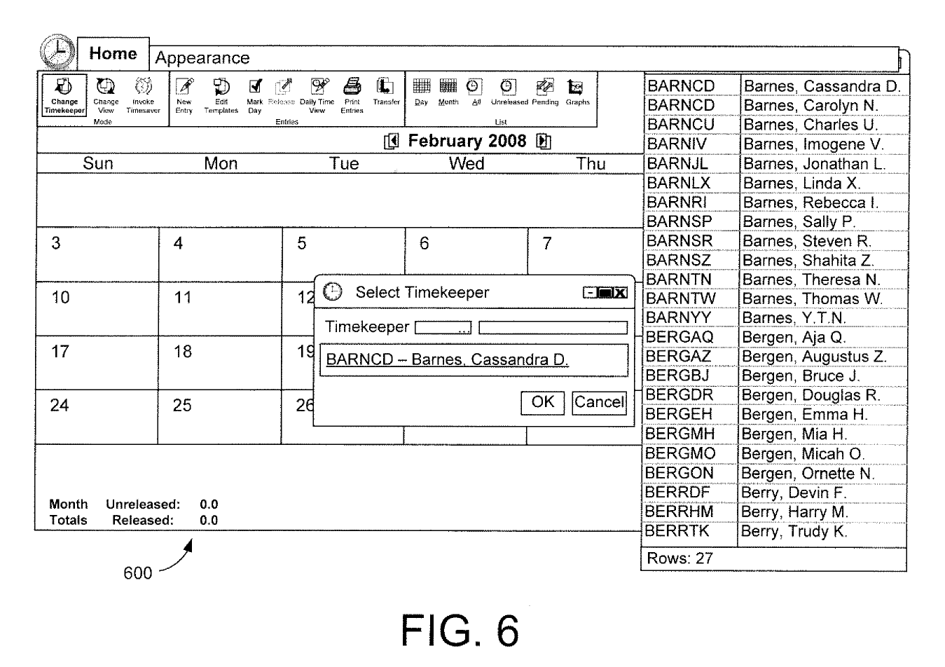

FIG. 6 illustrates one example graphical user interface (GUI) screen 600 that may be displayed to a professional or other user in order to facilitate the selection of a timekeeper by the user. As shown in FIG. 6, a timekeeper may be selected by the user entering identifying information for the timekeeper, for example, a timekeeper identification number, a timekeeper name code, and/or a name of the timekeeper. Alternatively, a timekeeper may be selected from a list of available timekeepers.

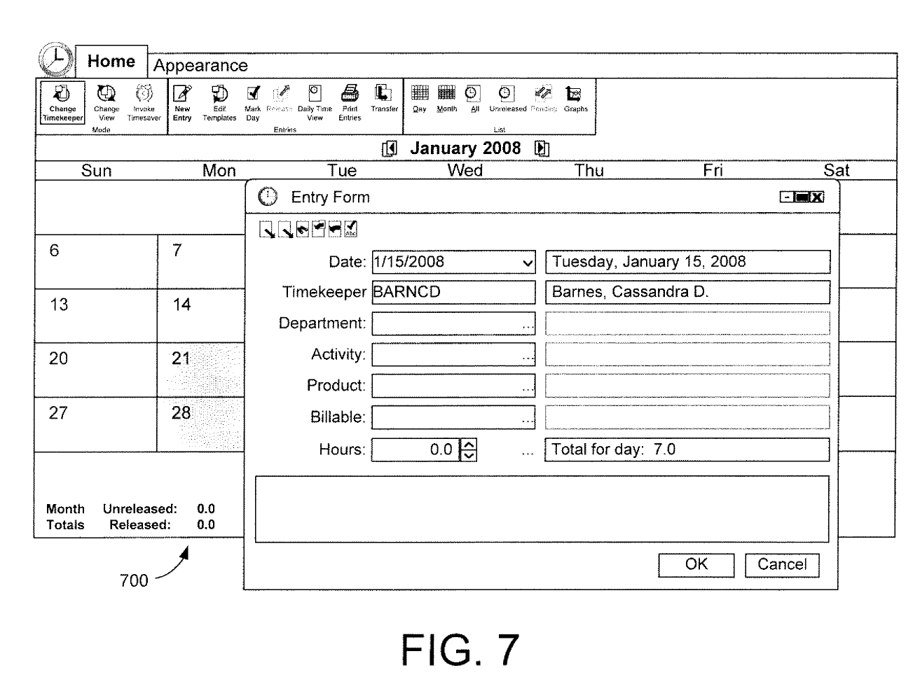

FIG. 7 illustrates one example graphical user interface (GUI) screen 700 that may be displayed to a professional or other user in order to facilitate the receipt of time entry and/or time recordation information. The user may input a description of a time entry as well as various identifying information for the time entry, for example, a client identifier, a client matter number, a cost code, a descriptive code associated with the type of work performed, etc. The user may further input a period of time associated with the time entry. Additionally or alternatively, the user may utilize the screen 700 to invoke a timer that tracks the amount of time that a user spends for the time entry. According to an aspect of the invention, once information associated with a new time entry has been input by the user, the new time entry may be stored in a pending queue and await synchronization with a central repository of time entry information.

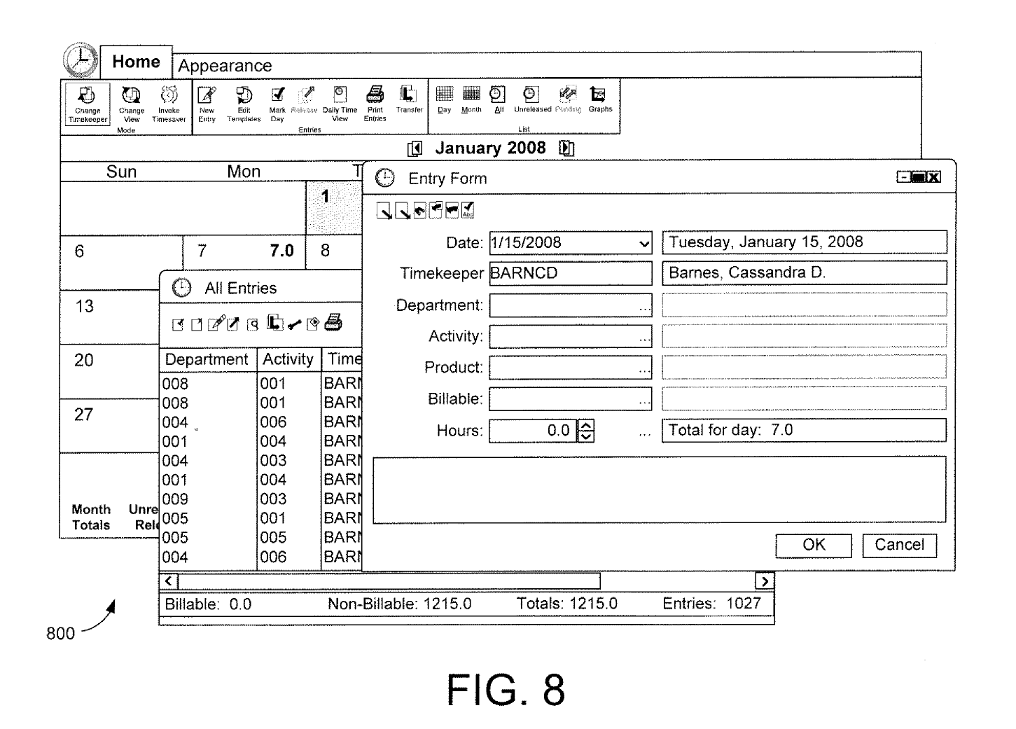

FIG. 8 illustrates one example graphical user interface (GUI) screen 800 that may be displayed to a professional or other user in order to facilitate the editing of time entry and/or time recordation information by the user. A list of time entries for the user may be displayed. The list may be organized in a wide variety of formats as desired in various embodiments of the invention. For example, the time entries for a particular day, for a particular client, etc. may be included in the list. A user may select a time entry from the list and more detailed information associated with the time entry may be displayed to the user in a form similar to the time entry form depicted above with reference to FIG. 7. The user may utilize the displayed form to edit various information associated with the time entry as desired. According to an aspect of the invention, once information associated with a modified time entry has been input by the user, the modified time entry may be stored in a pending queue and await synchronization with a central repository of time entry information.

The graphical user interfaces illustrated in FIGS. 5-8 are provided by way of example only and are not intended to be limited. It will be appreciated that a wide variety of different graphical user interfaces may be utilized as desired in various embodiments of the invention, including the graphical user interfaces illustrated in FIGS. 5-8.

Accordingly, example embodiments of the invention can provide the technical effects of entering and/or editing time entry information one a workstation without having access to a middle-tier or server that maintains a central repository of time entry information. Example embodiments of the invention may further have the technical effect of facilitating stateless database transactions associated with time entry information. In this regard, time entry information may be manipulated by a user of a workstation in an efficient and accurate manner regardless of whether the workstation is in communication with the middle-tier.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed

1. A method for facilitating data transactions in a time recordation system, comprising executing computer-executable instructions performed by one or more processors for:
receiving, at a client application from a timekeeper, a timekeeper identification associated with the timekeeper;
communicating, via a network to a middle-tier application, the received timekeeper identification and a request for time entry data associated with the timekeeper, wherein the middle-tier application accesses at least one database, retrieves the requested time entry data, and communicates the retrieved time entry data to the client application via the network;
receiving time entry data from the middle-tier responsive to the request for time entry data;
storing the time entry data received from the middle-tier in at least one local memory accessible by the client application;
generating a new time entry or modifying an existing time entry at the client application;
updating the time entry data stored in the at least one local memory based at least in part on the generated or modified time entry; and
communicating, via the network to the middle-tier application, the updated time entry data, wherein the middle-tier updates the at least one database based at least in part on the received updated time entry data.

2. The method of claim 1, further comprising executing computer-executable instructions performed by one or more processors for:
receiving, via the network from the middle-tier application, validation information that facilitates conforming time entries to designated business rules

3. The method of claim 2, further comprising executing computer-executable instructions performed by one or more processors for:
communicating, from the client application to the middle-tier application via the network, a request for validation information, wherein the validation information is received from the middle-tier application responsive to the request.

4. The method of claim 3, wherein communicating a request for validation information comprises communicating a request for validation information during an initial execution of the client application.

5. The method of claim 1, wherein communicating the updated time entry data to the middle-tier application comprises:
establishing a communication session between the client application and the middle-tier application via the network; and
communicating the updated time entry data to the middle-tier application via the established communication session.

6. The method of claim 1, wherein updating the time entry data stored in the at least one local memory comprises updating the time entry data while the client application is operating in an offline mode.

7. The method of claim 1, wherein updating the time entry data stored in the at least one local memory comprises storing updated time entries in a pending queue associated with the client application.

8. The method of claim 1, wherein the at least one local memory comprises one of a cache or a random access memory device.

9. The method of claim 1, further comprises executing computer-executable instructions for closing the client application, wherein the time entry data stored in the at least one local memory is stored in a persistent file when the client application is closed.

10. The method of claim 1, further comprising executing computer-executable instructions for:
receiving, via the network from the middle-tier application, updated time entry information; and
storing the received updated time entry information in the at least one local memory.

11. A system for tracking time entries in a time recordation system, the system comprising:
a network interface operable (i) to transmit, to a host server via a network, a timekeeper identification and a request for time entry data for a timekeeper, (ii) to receive, from the host server via the network, time entry data for the timekeeper, and (iii) to transmit, to the host server via the network, updated time entry data;
at least one local memory operable to store time entry data; and
at least one processor operable (i) to receive, from a timekeeper, the timekeeper identification associated with the timekeeper, (ii) to direct the network interface to transmit the timekeeper identification and the request for time entry data to the host server, (iii) to direct the storage of the received time entry data in the at least one local memory, (iv) to generate a new time entry or modify an existing time entry, (v) to direct the updating of the time entry data stored in the at least one local memory based at least in part on the generated or modified time entry, and (vi) to direct the network interface to transmit the updated time entry data to the host server.

12. The system of claim 11, wherein the network interface is further operable to receive, via the network from the host server, validation information that facilitates conforming time entries to designated business rules, and
wherein the at least one processor is further operable to direct the storage of the received validation information in the at least one local memory.

13. The system of claim 12, wherein the network interface is further operable to transmit, to the host server via the network, a request for the validation information, and
wherein the validation information is received in response to the request for the validation information

14. The system of claim 13, wherein the request for validation information is transmitted to the host server during an initial execution of the client application.

15. The system of claim 11, wherein the network interface is operable to transmit updated time entry data to the host server by establishing a communication session with the host server via the network and transmitting the updated time entry data to the host server via the established communication session.

16. The system of claim 11, wherein the at least one processor is operable to direct the updating of time entry data stored in the at least one local memory when no communication session exists between the network interface and the host server.

17. The system of claim 11, wherein the at least one process is further operable to stored updated time entries in a pending queue for updated time entries.

18. The system of claim 11, wherein the at least one local memory comprises one of a cache or a random access memory device.

19. The system of claim 11, wherein the at least one processor is further operable to direct the storage of the time entry data stored in the at least one local memory to a persistent memory file.

20. The system of claim 11, wherein the network interface is further operable to receive, via the network from the host server, updated time entry information, and
wherein the at least one process is further operable to direct the storage of the received updated time entry information in the at least one local memory.
